(19) United States
(12) Patent Application Publication
(10) Pub. No.: US 2013/0076149 A1
(43) Pub. Date: Mar. 28, 2013

(54) POWER-ON CONTROL CIRCUIT

(71) Applicants: MENG-CHE YU, Tu-Cheng (TW); CHENG-HUNG HSIAO, Tu-Cheng (TW)

(72) Inventors: MENG-CHE YU, Tu-Cheng (TW); CHENG-HUNG HSIAO, Tu-Cheng (TW)

(73) Assignee: HON HAI PRECISION INDUSTRY CO., LTD., Tu-Cheng (TW)

(21) Appl. No.: 13/279,314

(22) Filed: Oct. 23, 2011

(30) Foreign Application Priority Data
Sep. 23, 2011 (TW) 100134278

(51) Int. Cl. H02J 4/00

(52) U.S. Cl. 307/81

(57) ABSTRACT

An exemplary power-on control circuit includes power supplies and a control chip. Each power supply includes a power good pin to output a power good signal and an enable pin to receive an enable signal. When the enable pin of one power supply receives an enable signal, the one power supply will be powered on. When one power supply is powered on successfully, the power good pin of the one power supply will output a power good signal. The control chip includes input ports and output ports. Each input port corresponding to one output port. Each input port is connected to the power good pin of one power supply to receive a power good signal from the one power supply, and its corresponding output ports is connected to the enable pin of the one power supply to output an enable signal to the one power supply.

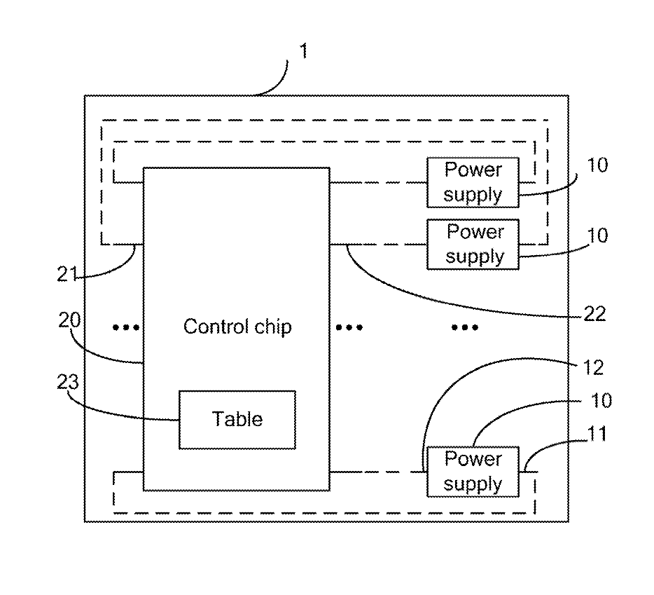

### BACKGROUND

1. Technical Field

The present disclosure relates to integrated circuit (IC) design and, particularly, to a power-on control circuit.

2. Description of Related Art

Power-on control circuits are commonly used in circuit environments where a number of voltage supplies are powered on sequentially. However, the conventional power-on control circuit may employ a number of control circuits, resulting in high cost. A power-on control circuit which employs a complex programmable logic device (CPLD) software program can power on a number of power supplies sequentially, and the CPLD software program can be altered by a software engineer to adjust power-on sequence of the power supplies using special software tools. However, it is difficult for an engineer or technician who is not familiar with software programming to edit the CPLD software program.

### BRIEF DESCRIPTION OF THE DRAWINGS

The components of the drawing are not necessarily drawn to scale, the emphasis instead being placed upon clearly illustrating the principles of the present disclosure.

The drawing is a schematic view of a power-on control circuit in accordance with an exemplary embodiment.

### DETAILED DESCRIPTION

The embodiments of the present disclosure are now described in detail, with reference to the accompanying drawing.

Referring to the drawing, a power-on control circuit 1 in accordance with an exemplary embodiment is shown. The circuit 1 includes a number of power supplies 10 and a control chip 20. Each power supply 10 is powered on at a power-on time. The power-on time of each power supply 10 can be changed. In the embodiment, different power supplies 10 are powered on at different power-on times, forming a sequence of powering-on the power supplies 10. The control chip 20 is to power on the power supplies 10 according to the sequence of powering-on the power supplies 10.

Each power supply 10 includes a power good pin (PG pin) 11 and an enable pin 12. The PG pin 11 of one power supply 10 is to output a power good signal for indicating the power supply 10 is powered on successfully. The enable pin 12 is to receive an enable signal transmitted from the control chip 20. The power supply 10 is powered on when the enable pin 12 of the power supply 10 receives an enable signal, and controls the PG pin 11 of the power supply 10 to output a power good signal when the power supply 10 is powered on successfully. In the embodiment, the interval between the time when the power supply 10 receives the enable signal and the time when the power supply 10 outputs the power good signal is very short and can be ignored, that is, the time of one power supply 10 receiving the enable signal and the time of the one power supply 10 outputting the power good signal can be considered as occurring at the same time. In this embodiment, each power supply 10 has a unique identification. The control chip 20 recognizes the power supplies 10 as a first power supply 10, a second power supply 10, and the like, according to their identifications. Hereinafter, for simplicity, the power supply 10 having the first identification is the first power supply 10, the power supply 10 having the second identification is the second power supply 10, and the like, and the power supply 10 having the last identification is the last power supply 10.

The control chip 20 includes a number of input ports 21 and a number of output ports 22. In the embodiment, the number of the input ports 21 is the same as that of the output ports 22. Each output port 22 corresponds to one input port 21. Each input port 21 is electrically connected to the PG pin 11 of one power supply 10, and the corresponding output port 22 is electrically connected to the enable pin 12 of the one power supply 10. For simplicity, the input port 21 connected to the PG pin 11 of the first power supply 10 is named the first input port 21, and the output port 22 connected to the enable pin 12 of the first power supply 10 is named the first output port 22, and so on, and the input port 21 connected to the PG pin 11 of the last power supply 10 is named the last input port 21, and the output port 22 connected to the enable pin 12 of the last power supply 10 is named the last output port 22. Each output port 22 is to output an enable signal to the enable pin 12 of one power supply 10 to power on the one power supply 10, and the corresponding input port 21 is to receive a power good signal from the one power supply 10. When the control chip 20 is powered on, the control chip 20 controls one output port 22 to output an enable signal to the enable pin 12 of one power supply 10 to power on the one power supply 10, and control another output port 22 to output an enable signal to the enable pin 12 of another power supply 10 to power on the another power supply 10 after the input port 21 corresponding to the output port 22 has received a power good signal from the one power supply 10.

In the embodiment, the control chip 20 includes a table 23 recording the sequence of powering-on the power supplies 10. In the embodiment, the table 23 includes a first row recording the identifications of the power supplies 10 in a desired power sequence and a second row recording time intervals. The sequence of the identifications in the first row indicates the sequence of powering on the power supplies 10. The time intervals are how long after a preceding power supply is powered that the next power supply in the sequence should power on. In this embodiment, there is no need for a programmed interval between the power on time of the control chip 20 and power on time of the first power supply 10. That is, when the control chip 20 is powered on, the control chip 20 will immediately power on the power supply 20 which is powered on firstly, such as third power supply, and then the time interval corresponding to the power supply next in line is allowed to elapse before powering the next in line. In this embodiment, the table 23 can be easily edited by an operator without the need of special software engineering or programming knowledge to adjust the sequence of powering-on the power supplies 10.

TABLE

| | IDs in sequence | | | |
|---|---|---|---|---|
| | Third | First | . . . | Last |
| Time interval | NA | 2 ms | . . . | 5 ms |

For example, when the control chip 20 is powered on, the control chip 20 controls the third output port 22 to output the enable signal to the enable pin 12 of the third power supply 10 to power on the third power supply 10 immediately according to the table 23. The third power supply 10 controls the PG pin 11 to output the power good signal to the third input port 21 of the control chip 20 when the third power supply 10 is powered on successfully. The control chip 20 controls the first output port 22 to output the enable signal to the enable pin 12 of the first power supply 10 when 2 ms elapses to power on the first power supply 10 according to the table 23. The first power supply 10 controls the PG pin 11 to output a power good signal to the first input port 21 of the control chip 20 when the first power supply 10 is powered on successfully. In the same manner, the rest of power supplies 10 are powered on sequentially by the control chip 20 according to the sequence recorded in the table 23.

In this embodiment, the power supplies 10 can be powered on sequentially according to the sequence by the control chip 20. Furthermore, re-editing the table 23 to adjust the sequence of powering-on the power supplies 10 does not require the services of a software engineer. However, for the power-on control circuit which employs a CPLD, only a software engineer can modify codes to adjust the sequence of powering-on the power supplies. Therefore, in this embodiment, it is convenient for operators to re-edit the table 23 to adjust the sequence of powering-on the power supplies.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A power-on control circuit comprising:
a plurality of power supplies, each of the power supplies comprising a power good pin and an enable pin, each of the power good pins being to output a power good signal, each of the enable pins being to receive an enable signal, when the enable pin of one of the power supplies receiving an enable signal, the one of the power supplies being powered on, and when one of the power supplies being powered on successfully, the power good pin of the one of the power supplies outputting a power good signal; and
a control chip comprising a plurality of input ports and a plurality of output ports, each of the input ports corresponding to one of the output ports, each of the input ports being connected to the power good pin of a corresponding one of the power supplies to receive a power good signal from the one power supply, and its corresponding output port being connected to the enable pin of the one power supply to output an enable signal to the one power supply; the control chip being to control one of the output ports to output an enable signal to the enable pin of one of the power supplies to power on the one power supply, and then control another one of the output ports to output an enable signal to the enable pin of another one of the power supplies to power on the another power supply after the input port corresponding to the one output port has received a power good signal.

2. The power-on control circuit as described in claim 1, wherein when the control chip is powered on, the control chip controls one of the output ports to output the enable signal to the enable pin of the corresponding one of the power supplies immediately, the power good pin of the one power supply outputs the power good signal to the input port corresponding to the one output port of the control chip when the one power supply is powered on successfully, the control chip then controls another one of the output ports to output the enable signal to the enable pin of the corresponding power supply of the another one output port when a first predetermined time elapses, in the same manner, the rest of the power supplies are powered on in a sequence.

3. The power-on control circuit as described in claim 2, wherein the control chip comprising a table recording the sequence of powering-on the power supplies.

4. The power-on control circuit as described in claim 3, wherein each of the power supplies has a unique identification, the table comprises a first row recording the identifications of the power supplies in a desired power sequence and a second row recording time intervals, the time intervals are how long after a preceding power supply is powered that the next power supply in the sequence should power on.

5. The power-on control circuit as described in claim 4, wherein the table is capable of being altered by an operator through a special software tool to adjust the sequence of powering-on the power supplies.
